(19) United States
(12) Patent Application Publication
(10) Pub. No.: US 2020/0373560 A1
(43) Pub. Date: Nov. 26, 2020

(54) Stabilized High Nickel NMC Cathode Materials for Improved Battery Performance

(71) Applicant: Nano One Materials Corp., Burnaby (CA)

(72) Inventors: Stephen A. Campbell, Burnaby (CA); Elahe Talaie, Burnaby (CA); Ahmad Esmaeilirad, Burnaby (CA)

(21) Appl. No.: 16/866,665

(22) Filed: May 5, 2020

Related U.S. Application Data
(60) Provisional application No. 62/850,777, filed on May 21, 2019.

(51) Int. Cl. H01M 4/36; H01M 4/505; H01M 10/0525; H01M 4/62; H01M 4/525

(52) U.S. Cl. CPC H01M 4/366; H01M 4/505; H01M 2004/028; H01M 4/628; H01M 4/525; H01M 10/0525

(57) ABSTRACT

An improved cathode material is provided which is particularly suitable for use in a lithium ion battery. The cathode material comprises particles comprising an oxide defined by the formula:

LiNiₐMn_{b}X_{c}G_{d}O₂

wherein G is an optional dopant; X is Co or Al; a≥0.5; b+c+d≤0.5; and d≤0.1. Each particle comprises a coating covering a surface of the particle wherein the coating comprises a salt of an oxide of a metal selected from the group consisting of vanadium, tantalum and niobium. An agglomerate comprises the particles wherein the agglomerate comprises interstitial interfaces. The interstitial interfaces comprise adjacent coatings on adjacent particles.

### CROSS-REFERENCE TO RELATED APPLICATIONS

This application claims priority to pending U.S. Provisional Patent Application No. 62/850,777 filed May 21, 2019 which is incorporated herein by reference.

### BACKGROUND

The present invention is related to the formation of high nickel NMC's which have superior stability resulting in the ability to undergo many charge/discharge cycles.

Cathode materials comprising nickel, manganese and cobalt, referred to as NMC's have proven to be very suitable for many applications. Particularly desirable are high nickel NMC's due to their expected high charge capacity. Unfortunately, NMC's with over about 50 mole % nickel, based on the transition metals, have proven to be unstable and therefore high nickel NMC's have seen limited success. Coatings of lithium niobate mitigate the deficiencies of the high nickel NMCs but the number of charge cycles is still not sufficient.

Without being limited to theory, it is hypothesized that during the formation of high nickel NMC's the particles agglomerate. Since this agglomeration occurs prior to the formation of the lithium niobate coating the agglomerate is coated as illustrated schematically in FIG. 1. In FIG. 1, an agglomerate, 8, of particles, 10, has a coating, 12, formed on the surface of the agglomerate. In the interior regions of the agglomerate particles have uncoated regions at the interstitial interfaces, 14, between particles and at interstitial surfaces, 15, of the particles which are not coated with lithium niobate. If the agglomerate is unperturbed the interior uncoated regions are of no consequence. Unfortunately, during the process of forming a cathode the particles may at least partially de-agglomerate leading to particles with uncoated surface, 11, as illustrated in FIG. 2 wherein the uncoated surface may originate from uncoated interstitial interfaces or interstitial surfaces. Yet another perturbation is believed to be the charging cycle which is hypothesized to also cause some de-agglomeration or, at least, sufficient separation at the particle boundaries to effective expose uncoated regions of the particles. The uncoated region is believed to be a source of degradation of the high nickel NMCs, particularly, when utilized with a liquid-based electrolyte.

Provided herein is an improved high nickel NMC wherein the individual particles are coated and the coated individual particles form an agglomeration. Therefore, during the normal process of cathode formation and charge/discharge any de-agglomerated particles have the entire surface coated thereby mitigating the effect of uncoated regions on the particles.

### SUMMARY OF THE INVENTION

It is an object of this invention to provide an improved high nickel NMC cathode for lithium ion batteries.

It is a particular object of the invention to provide a high nickel NMC cathode for lithium ion batteries which is stable to perturbations, such as repeated discharge/charge cycles, thereby providing for a high nickel NMC with superior performance and longevity in use.

A particular feature is the incorporation of a stabilizing coating on the interstitial interfaces and surfaces of the particles of the cathode material wherein the coating inhibits degradation, particularly, the degradation which occurs by liquid-based electrolyte attack.

An embodiment of the invention is provided in an improved cathode material for use in a lithium ion battery comprising: particles comprising an oxide defined by the formula:

LiNiₐMn_{b}X_{c}GdO₂

wherein G is an optional dopant;
X is Co or AI;
a≥0.5;
b+c+d≤0.5;
and d≤0.1; and each particle comprises a coating covering a surface of the particle wherein the coating comprises a salt of an oxide of a metal selected from the group consisting of vanadium, tantalum and niobium. An agglomerate comprises the particles wherein the agglomerate comprises interstitial interfaces. The interstitial interfaces comprise adjacent coatings on adjacent particles.

Yet another embodiment is provided in an agglomerate comprising particles comprising an oxide defined by the formula:

LiNiₐMn_{b}X_{c}GdO₂

wherein G is an optional dopant;
X is Co or Al;
a≥0.5;
b+c+d≤0.5;
and d≤0.1;
wherein the particles aggregate to form the agglomerate; and
a coating material between adjacent particles in the agglomerate.

### BRIEF DESCRIPTION OF THE FIGURES

FIG. 1 is a schematic representation of the prior art.

FIG. 2 is a schematic representation of the prior art.

FIG. 3 is a schematic representation of an embodiment of the invention.

FIG. 4 is a schematic representation of an isolated particle comprising a coating.

FIG. 5 is a graphical representation illustrating the advantages of an embodiment of the invention.

FIG. 6 is a graphical representation illustrating the advantages of an embodiment of the invention.

FIG. 7 is a graphical representation illustrating the advantages of an embodiment of the invention.

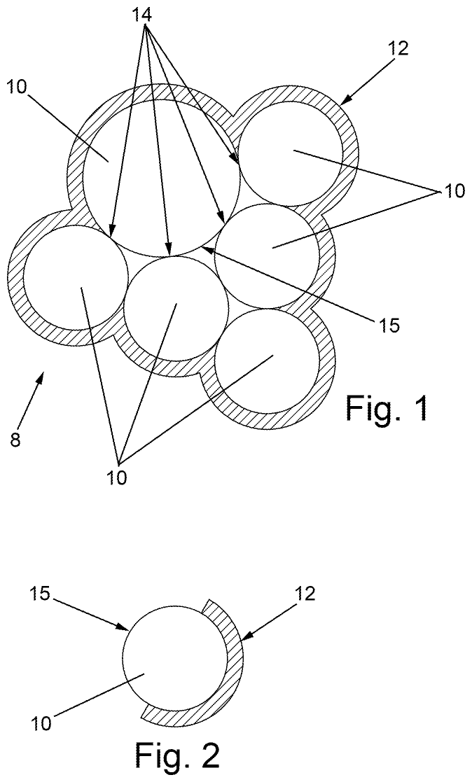

### DESCRIPTION

The instant invention is specific to an improved cathode for lithium ion batteries, and particularly high nickel NMC or NCA cathodes for lithium ion batteries. More specifically, the present invention is specific to a high nickel cathode for a lithium ion battery comprising a coating on the interstitial interfaces and interstitial surfaces of the particles forming an agglomerate wherein the coating inhibits the formation of space-charge regions and degradation at the surface.

In a preferred embodiment, the lithium metal compound of the instant invention is defined by the Formula;

LiNiₐMnbX_{c}GdO₂
wherein G is an optional dopant;
X is Co or Al;
a≥0.5;
b+c+d≤0.5;
and d≤0.1.

A preferred embodiment is a high nickel NMC wherein X is Co, 0.5≤a≤0.9 and more preferably 0.58≤a≤0.62, as represented by NMC 622, or 0.78≤a≤0.82 as represented by NMC 811.

In the formulas throughout the specification, the lithium is defined stoichiometrically to balance charge with the understanding that the lithium is mobile between the anode and cathode. Therefore, at any given time the cathode may be relatively lithium rich or relatively lithium depleted. In a lithium depleted cathode the lithium will be below stoichiometric balance and upon charging the lithium may be above stoichiometric balance. Likewise, in formulations listed throughout the specification the metals are represented in charge balance with the understanding that the metal may be slightly rich or slightly depleted, as determined by elemental analysis, due to the inability to formulate a perfectly balanced stoichiometry in practice. Throughout the specification specifically recited formulations are intended to represent the molar ratio of the metals within 10%. For LiNi_{0.6}Mn_{0.2}Co_{0.2}O₂, for example, each metal is stated within 10% of stoichiometry and therefore Ni_{0.6} represents Ni_{0.54} to Ni_{0.66}.

Dopants can be added to enhance the properties of the oxide such as electronic conductivity and stability. The dopant is preferably a substitutional dopant added in concert with the primary nickel, manganese and cobalt or aluminum. The dopant preferably represents no more than 10 mole% and preferably no more than 5 mole % in the oxide. Preferred dopants include Al, Gd, Ti, Zr, Mg, Ca, Sr, Ba, Mg, Cr, Cu, Fe, Zn, V, Bi, Nb and B with Al and Gd being particularly preferred.

The cathode is formed from an oxide precursor comprising salts of Li, Ni, Mn, Co or Al as will be more fully described herein. The oxide precursor is calcined to form the cathode material as a lithium metal oxide.

The particles of the cathode material are coated with a metal oxide of niobium, vanadium or tantalum with lithium niobate (LiNbO₃) being most preferred. The coating provides a passivation later which prevents degradation particularly when using a liquid-based electrolyte such as ethylene carbonate (EC):diethylene carbonate (DEC) 1:1 and decreases the space-charge resistance when using a solid-state electrolyte.

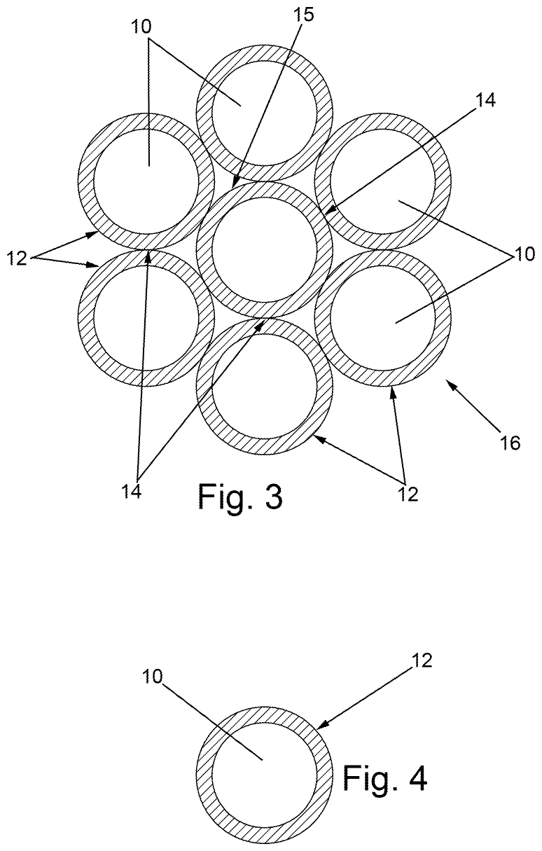

An embodiment of the invention will be described with reference to FIG. 3 which forms an integral non-limiting component of the invention. In FIG. 3, an agglomerate, 16, is illustrated schematically in cross-sectional view. The agglomerate comprises particles, 10, wherein the entire surface of the particle is coated with a protective coating, 12. A result of the entire surface being coated is the advantage that the interstitial interfaces, 14, are interfaces comprising coating and the interstitial surfaces, 15, are surfaces comprising coating. If any perturbation disturbs the agglomerate each particle has a completely coated surface as illustrated schematically in FIG. 4 wherein a completely dissociated particle is shown to have a complete surface coating. Complete dissociation of a particle is illustrated in FIG. 4 for the purposes of discussion with the understanding that most of the perturbations expose surfaces of the particles, or in the instant invention the coating on the particles, without necessarily complete dissociation of the particles. For the purposes of illustration and discussion the coatings of adjacent particles are illustrated as distinct and distinguishable. In an actual sample the coatings may form a homogenous layer between adjacent particles without the ability to necessarily distinguish a defined barrier between the coatings of adjacent particles. In other words, the coating may be distinguishable by visual and spectroscopic techniques as being distinct coatings or the coatings may appear as a continuum of coating material.

For the purposes of this disclosure interstitial interfaces of an agglomerate are defined as points of contact of adjacent particles, points of contact of the coating of adjacent particles or points of contact of a particle with the coating of an adjacent particle. For the purposes of this disclosure interstitial surfaces of an agglomerate are defined as a surface of a particle, or the surface of the coating of a particle, which is not in contact with an adjacent particle or the coating of an adjacent particle.

The coating has a preferred thickness of 5 to 10 nanometers over the entirety of the particles.

The oxide precursors are formed by the reaction of salts in the presence of counterions which form relatively insoluble salts. The relatively insoluble salts are believed to form suspended crystals which are believed to Ostwald ripen ultimately precipitating as an ordered lattice. For the purposes of the present invention salts of preferably manganese and nickel, and optionally cobalt or aluminum, combined in a solution comprising counterions which precipitate the manganese, nickel and cobalt or aluminum at a rate sufficient to allow crystalline growth. Soluble counterions of manganese, nickel, cobalt or aluminum are those having a solubility of at least 0.1 g of salt per 100 gram of solvent at 20° C. including acetate, nitrate or hydrogen carbonate. The metals are precipitated as insoluble salts having a solubility of less than 0.05 g of salt per 100 gram of solvent at 20° C. including carbonates and oxalates.

A particular advantage of the invention is the addition of those materials forming the precursor to the coating occurs prior to the particles forming an agglomerate thereby allowing for the formation of a complete coating on the surface of the particles. Upon dry down the particles agglomerate yet the surface of the particles is previously covered by coating thereby eliminating the formation of uncoated interstitial interfaces and interstitial surfaces. In contrast, prior art processes incorporate the coating precursors after agglomeration resulting in the formation of uncoated interstitial interfaces and interstitial surfaces. Alternatively, the prior art may rely on coating materials to bloom to the surface which does not effectively form a coating at, at least, the interstitial interfaces.

The overall reaction comprises two secondary reactions, in sequence, with the first reaction being the digestion of carbonate feedstock in the presence of an excess of multi-carboxylic acid as represented by Reaction A:

XCO₃(s)+2H⁺(aq)⇒X²⁺+CO₂(g)+H₂O(I) A

wherein X represents a metal suitable for use in a cathode material preferably chosen from Li₂, Ni, Mn, Co or Al. In Reaction A the acid is liberated by the multi-carboxylic acid which is not otherwise represented in Reaction A for simplicity. The result of Reaction A is a metal salt in solution wherein the salt is chelated by the deprotonated multi-carboxylic acid as represented by Reaction B:

X²⁺+⁻OOCR₁COO⁻→X(OOCR₁COO) B

wherein R¹ represents an alkyl chain comprising the multi-carboxylate. The salts represented by X(OOCR₁COO) precipitate in an ordered lattice as discussed elsewhere herein.

The metal carbonates of Reaction A can be substituted with metal acetates such as Li(O₂CCH₃), Ni(O₂CCH₃)₂ or Mn(O₂CCH₃)₂ which can be added as aqueous solutions or as solid materials.

The pH may be adjusted with ammonium hydroxide, if desired, due to the simplicity and improved ability to accurately control the pH. In the prior art processes the use of ammonium hydroxide caused difficulty due to the propensity for NH₃ to complex with nickel in aqueous solution as represented by the reaction:

[Ni(H₂O)₆]²⁺+xNH₃⇒[Ni(NH₃)ₓ(H₂O)₆₋ₓ]²⁺+xH₂O

The result is incomplete precipitation of nickel which complicates determination and control of stoichiometry of the final oxide precursor. Multi-carboxylic acids, and particularly oxalic acid, effectively coordinates nickel preferentially over NH₄⁺ thereby increasing the rate of precipitation and incorporation of nickel into the ordered oxide precursor. Preferential precipitation by multi-carboxylic acids drives the reaction towards nickel precipitation and avoids the use of ammonium hydroxide.

The carbonate digestion process in the presence of multi-carboxylic acids includes combining the metal carbonate and oxalic acid into a reactor, preferably in the presence of water, followed by stirring. The slurry is then dried, preferably by spray drying, followed by calcining. The calcination temperature can vary from 400 to 1000° C. to form materials with different structural properties.

A particular feature of the carbonate digestion process is the fact that there is no need to grind or blend the precursor powders, filter the slurry, or decant the supernatant even though these steps can be done if desired.

The carbonate digestion process or digestion(hydrolysis)-precipitation reaction, using oxalate as an example, can be described by the following equation which occurs preferably in the presence of water:

H₂C₂O_{4(aq)}+XCO₃₍ₛ₎→CO_{2(g)}+H₂O₍ₗ₎+XC₂O_{4(s,aq)}(X=transition metals, Li₂)

Without being limited to theory, it is hypothesized that the oxalic acid hydrolyses the carbonates to form CO_{2(g)}, H₂O₍ₗ₎, and metal ions. Transition metal ions are then precipitated as metal oxalates. Lithium oxalate might be precipitated or remain soluble in water, depending on the water content. The soluble lithium oxalate is expected to be coated on transition metal oxalate particles during spray-drying. There is no need to achieve complete dissolution of metal carbonates or oxalic acid as the water is simply a medium to digest the metal carbonates and precipitate out the metal oxalates in a controlled fashion thereby allowing for nucleation and crystal growth. The rate of the digestion(hydrolysis)-precipitation reaction depends on temperature, water content, pH, gas introduction, the crystal structure and morphology of the feedstocks.

The reaction can be completed in the temperature range of 10-100° C. with water reflux temperature being preferred in one embodiment due to the increased digestion reaction rate.

For each 1 g of oxalic acid the water content can vary from about 1 to about 400 ml with a preference for a decreased water content due to the increased reaction rate and less water must be removed subsequently.

The pH of the solution can vary from 0 to 12. A particular advantage of the carbonate digestion process is that the reaction can be done without additional pH control thereby simplifying the process and eliminating the need for additional process control or additions.

Whereas the reaction can be done under untreated atmospheric air other gases such as CO₂, N₂, Ar, other inert gases or O₂ can be used in some embodiments. In some embodiments N₂ and CO₂ bubbling into the solution are preferred as they may slightly increase the crystallinity of the precipitated metal oxalates.

The crystallinity and morphology of the precursors, such as amorphous vs. crystalline carbonate feedstocks can influence the rate of digestion due to the differences in solubility and particle size and range of particle size.

The carbonate digestion process proceeds via a cascading equilibrium from solid carbonate feedstocks to solid oxalate precursor materials. The process can be defined by several distinct processes, per the following reactions, for the purposes of discussion without limit thereto:

H₂C₂O₄₍ₛ₎→H₂C₂O_{4(aq)}(dissolution of oxalic acid) (1)

H₂C₂O_{4(aq)}↔H⁺_{(aq)}+HC₂O₄⁻_{(aq)}(oxalic acid dissociation step one, pKa=1.25) (2)

HC₂O₄_{^{−}}_{(aq)}↔H⁺_{(aq)}+C₂O₄²⁻_{(aq)}(oxalic acid dissociation step two, pKa=4.19) (3)

XCO_{3(s, aq)}+2H⁺_{(aq)}→X²⁺+H₂O_{(I)}+CO_{2(g)}(carbonate hydrolysis) (4)

X²⁺_{(aq)}+C₂O₄²⁻_{(aq)}→XC₂O₄₍ₛ₎(precipitation of metal oxalates) (5)

For the purposes of discussion and explanation the reactions are written stepwise with the understanding that under operational reaction conditions the reactions may be occurring simultaneously. By varying different reaction parameters such as water content/ionic strength, excess oxalic acid content, batch size, temperature, atmosphere, refluxing the reaction mixture, pH control, etc. the rates of each step can be controlled and other desirable parameters such as solids content can be optimized.

The carbonate digestion process can be described as proceeding in a cascading equilibrium as the evolution of CO_{2(g)} from solution, as in Reaction 4 above, and precipitation of highly insoluble metal oxalates, as in Reaction 5 above. Both CO₂ evolution and precipitation drive the reaction to completion.

Rates of carbonate hydrolysis are correlated to Kₛₚ of the metal carbonate with the following provided for convenience:
Lithium carbonate, Li₂CO₃, 8.15×10⁻⁴ Very fast (seconds to minutes);
Nickel(II) carbonate, NiCO₃, 1.42×10⁻⁷ Fast (minutes);
Manganese(II) carbonate, MnCO₃, 2.24×10⁻¹¹ Slower (hours to days); and
Aluminum hydroxide (Al(OH)₃, 3×10⁻³⁴ Very slow

The homogeneity of co-precipitation could depend on rates of carbonate hydrolysis. For example, if Nickel(II) carbonate is fully hydrolyzed before Manganese(II) carbonate, it may subsequently precipitate as NiC₂O₄ and MnC₂O₄ separately.

Temperature can be controlled as it influences the rates of dissolution of oxalic acid, carbonate hydrolysis, and precipitation of metal oxalates. Specifically, it would be useful to perform the reaction at water reflux temperature. CO_{2(g)} is produced in this reaction, and raising the temperature will increase the rate of removal of CO_{2(g)}, and therefore due to lower aqueous CO₂(_{g}) solubility at high temperatures increasing the temperature may increase the rate of carbonate hydrolysis.

Gas bubbling may also be an effective method of controlling the rates of reaction by altering the rate of CO₂ evolution. Bubbling of N_{2(g)}, O_{2(g)}, CO_{2(g)}, and/or atmospheric air may be beneficial as the gases may function to displace dissolve CO_{2(g)} or improve mixing of reactants.

The carbonates may digest faster if they are first in the form of the metastable bicarbonate. For example, the following reaction occurs for Li₂CO₃:

Li₂CO₃₍ₛ₎+CO_{2(g)}+H₂O_{(I)}↔2LiHCO_{3(aq)}

The metastable lithium bicarbonate is far more soluble than Li₂CO₃ and the subsequent hydrolysis can proceed stoichiometrically with a single proton as shown below:

LiHCO_{3(aq)}+H⁺_{(aq)}→H₂O_{(I)}+CO_{2(g)}+Li⁺_{(aq)I}

as opposed to proceeding as Reaction 4 above.

Divalent metal oxalates such as NiC₂O₄, MnC₂O₄, CoC₂O₄, ZnC₂O₄, etc. are highly insoluble, however monovalent metal oxalates such as Li₂C₂O₄ are somewhat soluble with a solubility of 8 g/100 mL at 25° C. in water. If it is necessary to have the lithium oxalate in solution and homogeneously dispersed throughout a mixed metal oxalate precipitate, then keeping the water volume above the solubility limit of lithium oxalate may be advantageous.

The rates of carbonate hydrolysis, metal oxalate precipitation, and the crystal structure and particle size of the metal oxalate precipitate is influenced by pH and water content or ionic strength. In some embodiments it may be beneficial to work at higher ionic strength, or lower water content as this increases the proton activity of oxalic acid, and rates of precipitation of metal oxalates. Water content can be normalized to carbonate feedstock content with a preferred ratio of moles of carbonates to volume of water in L being in the range of about 0.05 to about 20. A water content of about 1.64 L per 1.25 moles of carbonates provides a ratio of moles of carbonates to volume of water in L of 1.79 which is suitable for demonstration of the invention.

A stoichiometric amount of oxalate to carbonate is sufficient to achieve complete precipitation. However, adding excess oxalic acid can increase the reaction rate as the second proton on oxalic acid is much less acidic and is involved in the hydrolysis. About 5% excess oxalic acid by mole to carbonates is sufficient to ensure completion of carbonate hydrolysis. Inductively coupled plasma mass spectrometry (ICP) analyses have shown that 10% excess oxalic acid leaves a similar number of Mn/Ni ions in solution as 0% stoichiometric excess by the completion of the reaction. A small stoichiometric excess of oxalic acid should be effective in achieving complete precipitation however a low stoichiometric excess may impact the rate of carbonate hydrolysis.

A particular advantage of the carbonate digestion process is the ability to do the entire reaction in a single reactor until completion. As the lithium source is ideally in solution prior to the spray drying and calcination steps, it may be useful and/or possible to precipitate the transition metals separately and to add the lithium source after co-precipitation as a solution of an aqueous lithium salt such as oxalate.

A coating metal precursor salt, wherein the metal will not incorporate into the lattice, can be added after digestion to eventually form the metal oxide coating comprising vanadium, tantalum or niobium. A particularly preferred metal is niobium and a particularly preferred niobium precursor, as the coating metal precursor salt, is a dicarboxylic acid salt with oxalate being most preferred. The preferred niobium oxalate can be formed in-situ from niobium carbonate or niobium oxalate can be prepared separately and added to the cathode metal precursors. It is preferable that the coating comprise predominantly the coating material as a lithium salt, lithium niobate for example, wherein at least 95 mole percent of the coating is the lithium salt of the coating metal oxide or less than 5 mole percent of the metal ion in the coating is a lithium salt of an active cathode material. In a particularly preferred embodiment the metal in the coating is at least 95 mole percent lithium niobate.

The invention is suitable for use with transition metal acetates and mixed carbonate feedstocks thereby allowing the solubility of the metal complexes to be more closely matched. Mixed carbonate feedstock such as Ni_{0.25}Mn_{0.75}CO₃+Li₂CO₃ to produce a LiNi_{0.5}Mn_{1.5}O₄ material are contemplated. Feedstock impurities may be critical to the performance of final materials. In particular, samples of MnCO₃ may have small quantities of unknown impurities which are not hydrolyzed during refluxing.

Multi-carboxylic acids comprise at least two carboxyl groups. A particularly preferred multi-carboxylic acid is oxalic acid due, in part, to the minimization of carbon which must be removed during calcining. Other low molecular weight di-carboxylic acids can be used such as malonic acid, succinic acid, glutaric acid and adipic acid. Higher molecular weight di-carboxylic acids can be used, particularly with an even number of carbons which have a higher solubility, however the necessity of removing additional carbons and decreased solubility renders them less desirable. Other acids such as citric, lactic, oxaloacetic, fumaric, maleic and other polycarboxylic acids can be utilized with the proviso they have sufficient solubility to achieve at least a small stoichiometric excess and have sufficient chelating properties. It is preferable that acids with hydroxyl groups not be used due to their increased hygroscopic characteristics.

To accomplish the reaction to form the oxide precursor solutions of the starting salts are prepared. It is preferable to prepare added solutions, preferably comprising the nickel, manganese and cobalt or aluminum solutions either collectively, separately, or in some combination, and a bulk solution preferably comprising the lithium. The added solution comprising the metal is then added, as described elsewhere herein, to the bulk solution. The solutions can be reversed, however, it is preferable that the transition metals be added in the intended stoichiometry and it is therefore advantageous to add as a single solution comprising all transition metals to a lithium containing bulk solution.

Each solution is prepared by dissolving the solid in a selected solvent, preferably a polar solvent, such as water, but not limited thereto. The choice of the solvent is determined by the solubility of the solid reactant in the solvent and the temperature of dissolution. It is preferred to dissolve at ambient temperature and to dissolve at a fast rate so that solubilization is not energy intensive. The dissolution may be carried out at a slightly higher temperature but preferably below 100° C. Other dissolution aids may be addition of an acid or a base.

During mixing it is preferable to bubble gas into the bulk solution. For the purposes of discussion the gas is defined as inert, which has no contribution to the chemical reaction, or the gas is defined as reactive, which either adjust the pH or contributes to the chemical reaction. Preferred gases include air, CO₂, NH₃, SF₆, HF, HCl, N₂, helium, argon, methane, ethane, propane or mixtures thereof. A particularly preferred gas includes ambient air unless the reactant solutions are air-sensitive. Carbon dioxide is particularly preferred if a reducing atmosphere is required and it can also be used as a dissolution agent, as a pH adjusting agent or as a reactant if carbonates are formed. Ammonia may also be introduced as a gas for pH adjustment. Ammonia can form ammonia complexes with transition metals and may assist in dissolving such solids. Mixtures of gases may be employed such as 10% O₂ in argon as an example.

For the formation of the oxide precursor the pH is preferably at least about 1 to no more than about 9.6 without limit thereto. Ammonia, or ammonium hydroxide, is suitable for increasing pH as is any soluble base with LiOH being particularly preferred for adjustment if necessary. Acids, particularly formic acid, are suitable for decreasing pH if necessary. In one embodiment lithium can be added, such as by addition of lithium acetate to achieve adequate solids content, typically about 20 to 30 wt %, prior to drying.

A particular advantage of the instant invention is the ability to form gradients of transition metal concentration throughout the body of the oxide wherein regions, the center for example, can have one ratio of transition metals and that ratio can vary in either continuous fashion or step-wise fashion through the body of the oxide. Considering NMC for the purposes of discussion and clarification without limit thereto, the concentration of Ni, Mn and Co can change radially from the core towards the surface of a particle. In an exemplary embodiment provided for clarity, the Ni content can be in a gradient thereby allowing a relatively low nickel concentration on or near the surface of the oxide particle and relatively high nickel concentration in the core of the oxide particle. The ratio of Li to transition metals would remain constant, based on neutral stoichiometry, throughout the oxide particle. By way of clarifying example, the overall compositions of Ni:Mn:Co may be 6:2:2 and 8:1:1 for NMC 622 and NMC 811, respectively, with the core being relatively rich in one transition metal and the shell being relative poor in the same transition metal. Even more specifically, the core may be rich in one transition metal, nickel for example, with a radially decreasing ratio in that transition metal relative to the others. An NMC 8:1:1 core, for example may have exterior thereto an NMC 6:2:2 shell with an NMC 1:1:1 shell on the exterior as a non-limiting step-wise example. These reactions can be done in step-wise additions, or in a continuous gradient by altering the pump rates of the transition metals. The ratio of transition metals in each addition and the number of additions can be altered to obtain desired gradient distributions.

A particular feature of the instant invention is the ability to incorporate dopants and other materials either preferentially in the interior of the oxide or towards the surface or even at the surface. With prior art techniques dopants, for example, are homogenously dispersed within the oxide. Furthermore, any surface treatment, such as with aluminum, is on a formed oxide as a surface reactant not necessarily as an atom incorporated into the oxide lattice. The present invention allows dopants to be dispersed systematically at the core, as would be the case if the dopant were incorporated into the initial transition metal slurry, in a radial band, as would be the case if the dopant were incorporated into a subsequent transition metal slurry, or in an outer shell, as would be the case if the dopant were incorporated into the final transition metal slurry.

For the purposes of the instant invention, each radial portion of the oxide particle will be defined based on the percentage of transition metal used to form the portion. By way of example, if the initial slurry has a first ratio of transition metals, and the initial slurry comprises 10 mol % of the total transition metal used to form the oxide, the core will be considered to be 10% of the volume of the oxide and the composition of the core will be defined as having the same ratio as the first ratio of transition metals. Similarly, each shell surrounding the core will be defined by the percentage of transition metal therein. By way of non-limiting example, a precursor to the oxide formed with three slurries, each of equal moles of transition metal, wherein the first slurry had a Ni:Mn:Co ratio of 8:1:1, the second slurry had a Ni:Mn:Co ratio of 6:2:2 and the third slurry had a Ni:Mn:Co ratio of 1:1:1 would be considered to form an oxide representing 1/3 of the volume of the oxide particle being a core with transition metals in the ratio of 8:1:1, a first shell on the core representing 1/3 of the volume of the oxide particle with a transition metal ratio of 6:2:2 and an outer shell on the first shell representing 1/3 of the volume of the oxide particle with a transition metal ratio of 1:1:1 without regards for the migration of transition metals which may occur during sintering of the precursor to the oxide.

In a particularly preferred embodiment, a dopant is incorporated into an outer shell, interior to the coating, with a particular dopant being aluminum. More preferably, the shell comprising the dopant represents less than 10% of the volume of the oxide particle, even more preferably less than 5% of the volume of the oxide particle and most preferably no more than 1% of the volume of the oxide particle. For the purposes of the present invention a dopant is defined as a material precipitated during the formation of the precursor to the oxide in concert with at least one transition metal selected from Ni, Mn, Co, Al and Fe. More preferably, the precursor to the oxide comprises Ni and Mn and optionally either Co or Al. A material added after completion of the precipitation of at least one transition metal is defined herein as a surface treatment with niobium, and particularly lithium niobate, being preferred.

Upon completion of the reaction to form the oxide precursor, the resulting slurry mixture is dried to remove the solvent and to obtain the dried precursor powder. Any type of drying method and equipment can be used including spray dryers, tray dryers, freeze dryers and the like, chosen depending on the final product preferred. The drying temperatures would be defined and limited by the equipment utilized and such drying is preferably at less than 350° C. and more preferably 200-325° C. Drying can be done using an evaporator such that the slurry mixture is placed in a tray and the solvent is released as the temperature is increased. Any evaporator in industrial use can be employed. A particularly preferred method of drying is a spray dryer with a fluidized nozzle or a rotary atomizer. These nozzles are preferably the smallest size diameter suitable for the size of the oxide precursor in the slurry mixture. The drying medium is preferably air due to cost considerations.

The particle sizes of the oxide precursor are of nanosize primary and secondary particles and up to small micron size secondary particles or agglomerates ranging to less than 50 micron aggregates which are very easily crushed to smaller size. It should be known that the composition of the final powder influences the morphology as well. The oxide precursor has a preferred particle size of about 1-5 μm. The resulting mixture is continuously agitated as it is pumped into the spray dryer head if spray dryers, freeze dryers or the like are used. For tray dryers, the liquid evaporates from the surface of the solution.

The dried powders are transferred into the calcining system batch-wise or by means of a conveyor belt. In large scale production, this transfer may be continuous or batch. The calcining system may be a box furnace utilizing ceramic trays or saggers as containers, a rotary calciner, a fluidized bed, which may be co-current or counter-current, a rotary tube furnace and other similar equipment without limit thereto.

The heating rate and cooling rate during calcinations depend on the type of final product desired. Generally, a heating rate of about 5° C. per minute is preferred but the usual industrial heating rates are also applicable.

The final powder obtained after the calcining step is a fine, ultrafine or nanosize powder that may not require additional crushing, grinding or milling as is currently done in conventional processing. Particles are relatively soft and not sintered as in conventional processing.

The final calcined oxide powder is preferably characterized for surface area, particle size by electron microscopy, porosity, chemical analyses of the elements and also the performance tests required by the preferred specialized application.

The spray dried oxide precursor is preferably very fine and nanosize.

A modification of the spray dryer collector such that an outlet valve opens and closes as the spray powder is transferred to the calciner can be implemented. Batchwise, the spray dried powder in the collector can be transferred into trays or saggers and moved into a calciner. A rotary calciner or fluidized bed calciner can be used to demonstrate the invention. The calcination temperature is determined by the composition of the powder and the final phase purity desired. For most oxide type powders, the calcination temperatures range from as low as 400° C. to slightly higher than 1000° C. After calcination, the powders are sieved as these are soft and not sintered. The calcined oxide does not require long milling times nor classifying to obtain narrow particle size distribution.

The LiMO₂ has a preferred crystallite particle size forming the agglomerate of about 5-250 nm and more preferably about 150-200 nm.

A particular advantage of the present invention is the formation of metal chelates of multi-carboxylic acids as opposed to acetates. Acetates function as a combustion fuel during subsequent calcining of the oxide precursor and additional oxygen is required for adequate combustion. Lower molecular weight multi-carboxylic acids, particularly lower molecular weight dicarboxylic acids, and more particularly oxalic acid, decompose at lower temperatures without the introduction of additional oxygen. The oxalates, for example, decompose at about 300° C., without additional oxygen, thereby allowing for more accurate control of the calcining temperature.

This method for forming the oxide precursor is referred to herein as the complexometric precursor formulation (CPF) method which is suitable for large scale industrial production of high performance fine, ultrafine and nanosize powders requiring defined unique chemical and physical properties that are essential to meet performance specifications for specialized applications. The CPF method provides an oxide precursor wherein the metals are precipitated as salts into an ordered lattice. The oxide precursor is then calcined to form the oxide. While not limited to theory, it is hypothesized that the formation of an ordered lattice, as opposed to an amorphous solid, facilitates oxide formation during calcination.

The CPF method provides for the controlled formation of specialized microstructures or nanostructures and a final product with particle size, surface area, porosity, phase purity, chemical purity and other essential characteristics tailored to satisfy performance specifications. Powders produced by the CPF method are obtained with a reduced number of processing steps relative to currently used technology and can utilize presently available industrial equipment.

The CPF method is applicable to any inorganic powder and organometallic powders with electrophilic or nucleophilic ligands. The CPF method can use low cost raw materials as the starting raw materials and if needed, additional purification or separation can be done in-situ. Inert or oxidative atmospheric conditions required for powder synthesis are easily achieved with the equipment for this method. Temperatures for the reactions can be ambient or slightly warm but preferably not more than 100° C.

The CPF method produces fine, ultrafine and nanosize powders of precursor oxides in a simple efficient way by integrating chemical principles of crystallization, solubility, transition complex formation, phase chemistry, acidity and basicity, aqueous chemistry, thermodynamics and surface chemistry.

The time when crystallization begins and, in particular, when the nucleation step begins, is the most crucial stage of formation of nanosize powders. A particular advantage provided by CPF is the ability to prepare the nanosize particles at the onset of this nucleation step. The solute molecules from the starting reactants are dispersed in a given solvent and are in solution. At this instance, clusters are believed to begin forming on the nanometer scale under the right conditions of temperature, supersaturation, and other conditions. The clusters constitute the nuclei wherein the atoms begin to arrange themselves in a defined and periodic manner which later defines the crystal microstructure. Crystal size and shape are macroscopic properties of the crystal resulting from the internal crystal lattice structure.

After the nucleation begins, crystal growth also starts and both nucleation and crystal growth may occur simultaneously as long as supersaturation exists. The rate of nucleation and growth is determined by the existing supersaturation in the solution and either nucleation or growth occurs over the other depending on the supersaturation state. It is critical to define the concentrations of the reactants required accordingly in order to tailor the crystal size and shape. If nucleation dominates over growth, finer crystal size will be obtained. The nucleation step is a very critical step and the conditions of the reactions at this initial step define the crystal obtained. By definition, nucleation is an initial phase change in a small area such as crystal forming from a liquid solution. It is a consequence of rapid local fluctuations on a molecular scale in a homogeneous phase that is in a state of metastable equilibrium. Total nucleation is the sum effect of two categories of nucleation—primary and secondary. In primary nucleation, crystals are formed where no crystals are present as initiators. Secondary nucleation occurs when crystals are present to start the nucleation process. It is this consideration of the significance of the initial nucleation step that forms the basis for the CPF method.

In the CPF method, the reactants are dissolved in a solution preferably at ambient temperature or, if needed, at a slightly elevated temperature but preferably not more than 100° C. Selection of inexpensive raw materials and the proper solvent are important aspects of this invention. The purity of the starting materials are also important since this will affect the purity of the final product which may need specified purity levels required for its performance specifications. As such, low cost starting materials which can be purified during the preparation process without significantly increasing the cost of processing must be taken into consideration.

CPF uses conventional equipment to intimately mix reactants and preferably includes a highly agitated mixture preferably with bubbling of gas, particularly, when reactant gas is advantageous.

It is preferred that the gas be introduced directly into the solution without limit to the method of introduction. The gas can be introduced into the solution within the reactor by having several gas diffusers, such as tubes, located on the side of the reactor, wherein the tubes have holes for the exit of the gas. Another configuration is to have a double wall reactor such that the gas passes through the interior wall of the reactor. The bottom of the reactor can also have entry ports for the gas. The gas can also be introduced through the agitator shaft, creating the bubbles upon exiting. Several other configurations are possible and the descriptions of these arrangements given herein are not limited to these.

In one embodiment an aerator can be used as a gas diffuser. Gas diffusing aerators can be incorporated into the reactor. Ceramic diffusing aerators which are either tube or dome-shaped are particularly suitable for demonstration of the invention.

The pore structures of ceramic bubble diffusers can produce relatively fine small bubbles resulting in an extremely high gas to liquid interface per cubic feet per minute (cfm) of gas supplied. A ratio of high gas to liquid interface coupled with an increase in contact time due to the slower rate of the fine bubbles can provide for a higher transfer rates. The porosity of the ceramic is a key factor in the formation of the bubble and significantly contributes to the nucleation process. While not limited thereto for most configurations a gas flow rate of at least one liter of gas per liter of solution per minute is suitable for demonstration of the invention.

A ceramic tube gas diffuser on the sides of the reactor wall is particularly suitable for demonstration of the invention. Several of these tubes may be placed in different positions, preferably equidistant from each other, to more uniformly distribute gas throughout the reactor. The gas is preferably introduced into the diffuser within the reactor through a fitting connected to the header assembly which slightly pressurizes the chamber of the tube. As the gas permeates through the ceramic diffuser body, fine bubbles may start to form by the porous structure of the material and the surface tension of the liquid on the exterior of the ceramic tube. Once the surface tension is overcome, a minute bubble is formed. This small bubble then rises through the liquid forming an interface for transfer between gas and liquid before reaching the surface of the liquid level.

A dome-shaped diffuser can be placed at the bottom of the reactor or on the sides of the reactor. With dome shaped diffusers a plume of gas bubbles is typically created which is constantly rising to the surface from the bottom providing a large reactive surface.

A membrane diffuser which closes when gas flow is not enough to overcome the surface tension is suitable for demonstration of the invention. This is useful to prevent any product powder from being lost into the diffuser.

In order to have higher gas efficiencies and utilization, it is preferred to reduce the gas flow and pressure and expend less pumping energy. A diffuser can be configured such that for the same volume of gas, smaller bubbles are formed with higher surface area than if fewer larger bubbles are formed. The larger surface area means that the gas dissolves faster in the liquid. This is advantageous in solutions wherein the gas is also used to solubilize the reactant by increasing its solubility in the solution.

Nozzles, preferably one way nozzles, can be used to introduce gas into the solution reactor. The gas can be delivered using a pump and the flow rate should be controlled such that the desired bubbles and bubble rates are achieved. A jet nozzle diffuser, preferably on at least one of the sides or bottom of the reactor, is suitable for demonstration of the invention.

The rate of gas introduction is preferably sufficient to increase the volume of the solution by at least 5% excluding the action of the agitator. In most circumstances at least about one liter of gas per liter of solution per minute is sufficient to demonstrate the invention. It is preferable to recycle the gas back into the reactor.

Transfer of the added solution into the bulk solution is preferably done using a tube attached to a pump connecting the solution to be transferred to the reactor. The tube into the reactor is preferably a tube with a single orifice or several orifices of a chosen predetermined internal diameter such that the diameter size can deliver a stream of the added solution at a given rate. Atomizers with fine nozzles are suitable for delivering the added solution into the reactor. The tip of this transfer tube can comprise a showerhead thereby providing several streams of the added solution simultaneously. In large scale production, the rate of transfer is a time factor so the transfer rate should be sufficiently rapid to produce the right size desired.

The agitator can be equipped with several propellers of different configurations, each set comprising one or more propellers placed at an angle to each other or on the same plane. Furthermore, the mixer may have one or more sets of these propellers. The objective is to create sufficient turbulence for adequate solution turnover. Straight paddles or angled paddles are suitable. The dimensions and designs of these paddles determine the type of flow of the solution and the direction of the flow. A speed of at least about 100 rotations per minute (rpm's) is suitable for demonstration of the invention.

The rate of transfer of added solution to the bulk solution has a kinetic effect on the rate of nucleation. A preferred method is to have a fine transfer stream to control the local concentration of the reactants which influences nucleation and the rate of nucleation over the rate of crystal growth. For smaller size powder, a slower transfer rate will yield finer powders. The right conditions of the competing nucleation and growth must be determined by the final powder characteristics desired. The temperature of reaction is preferably ambient or under mild temperatures if needed.

Special nanostructures are preformed which are carried over to the final product thus enhancing the performance of the material in the desired application. For the purposes of the present invention nanostructures are defined as structures having an average size of 100 to 300 nm primary particles.

Neither surfactants nor emulsifiers are necessary. In fact, it is preferable that surfactants and emulsifiers are not used since they may inhibit drying.

Size control can be done by concentration of the solutions, flow rate of the gas or transfer rate of added solution to the bulk solution.

No repetitive and cumbersome milling and classification steps are used.

Reduced calcination time can be achieved and repetitive calcinations are typically not required.

Reaction temperature is ambient. If need for solubilization, temperature is increased but preferably not more than 100° C.

Tailored physical properties of the powder such as surface area, porosity, tap density, and particle size can be carefully controlled by selecting the reaction conditions and the starting materials.

The process is easily scalable for large scale manufacturing using presently available equipment and/or innovations of the present industrial equipment.

It is generally understood, in the prior art, that the morphology of cathode material comprises dense, polycrystalline spheres of between 3 and 30 μm in diameter and that these are compressed into a cathode layer on an aluminum foil to make an electrode for a lithium ion cell with additional carbon and binder (e.g. PVDF). The electrode layer is generally calendared to a porosity of around 30% to allow the electrolyte (e.g. 1M LiPF₆ in EC/DEC 30/70) to form an interface with the surface of the cathode material. It is generally required that (i) these spheres are coated to prevent side reactions such as electrolyte oxidation and transition metal dissolution and (ii) the surface area is reduced by optimization of the size of the spheres. Packing of these spheres into an electrode layer requires optimization of surface area for performance and durability.

The method described herein produces a cathode material that has a different morphology that may be optimized to enhance both performance and durability. The cathode material described comprises nano-crystals of cathode material comprising lithium transition metal oxides of the general formulae of LiMO₂ or LiM₂O₄ where each of the individual nano-crystals is doped and coated with a protective layer comprising a second metal oxide which prevents unwanted side reactions while not impeding Li⁺ transport to the first cathode material. These coated nano-crystals form agglomerates in the described process that are a similar average size to the prior art but are porous, allowing a larger interface between the electrode and the electrolyte whilst being protected from side reactions by the second oxide coating described above. This difference in morphology means that electrodes calendared to a similar porosity or pore volume, will have a different pore size distribution (PSD) having a significant proportion of that pore volume comprising micropores.

When prior art material, comprising hard, dense, polycrystalline, coated spheres are calendared in the formation of an electrode it is a concern that these spheres may fracture, exposing unprotected cathode material. This may also occur during changes in volume that take place during cell charge/ discharge cycling in normal use. Both these effects will have an adverse effect on the durability of the cell performance. In the art described here, the agglomerate secondary particles may be compressed during calendaring and may even fracture without exposing unprotected cathode material as each individual nano-crystal is coated. Also, the microporosity produced by the morphology described increases the electrode/ electrolyte interface which may enable high rates of charge and discharge without an adverse effect on durability. The coating of the individual nano-crystals means that the active surface of the electrode does not need to be reduced to impart sufficient durability and the overall performance of the cell will be significantly improved.

### EXAMPLES Electrode preparations:

The composite electrodes were prepared by mixing the active material with 10 wt % conductive carbon black, as a conductive additive, 5 wt % polyvinylidene fluoride (PVDF), as a binder, dissolved in N-methyl-2-pyrrolidinone (NMP) solvent. The slurry was cast on graphite-coated aluminum foil and dried overnight at 60° C. under vacuum. Electrode disks with an area of 1.54 cm² were cut form the electrode sheets with a typical loading of 4 mg.cm⁻².

### Coin Cell Assembly:

Coin cells were assembled in an argon-filled glovebox. Lithium foil (340 μm) was used as counter and reference electrodes in half-cells, and commercial Li₄Ti₅O₁₂ (LTO) composite electrodes were used as counter and reference electrodes in full-cells. 1 M LiPF₆ in 7:3 (vol %) ethylene carbonate (EC):diethylene carbonate (DEC) was used as the electrolyte. The electrodes were separated by one or two 25 μm thick sheets of Celgard® membranes in half-cells, and one sheet of Celgard membrane full-cells.

### Cycling Protocol:

The cathode cells were galvanostatically cycled in the voltage range of 3.5 V-4.9 Vat various C-rates (1 C rate equivalent to 146 mAg⁻¹) at 25° C., using an Arbin Instrument battery tester (model number BT 2000). A constant voltage charging step at 4.9 V for 10 minutes was applied to the cells at the end of 1 C or higher rate galvanostatic charging steps. The rock-salt NMC cells were galvanostatically cycled in the voltage range of 2.7V-4.35 V at various C-rates (1 C rate equivalent to 200 mAg⁻¹) at 25° C. A constant voltage charging step of 4.35 V for 10 minutes was applied to the cells at the end of 1 C or higher rate galvanostatic charging step.

### Comparative Example 1

A precursor for NMC 811 having formula LiNi_{0.8}Mn_{0.1}Co_{0.1}O₂ was prepared from 39 g Li₂CO₃, 95 g NiCO₃, 12 g MnCO₃, and 12 g CoCO₃ dispersed in 200 mL of deionized water in a beaker. The mixture was pumped into a separate beaker containing 201 g of H₂C₂O₄.2H₂O in 400 mL of deionized water at a rate of 0.38 moles of carbonates per hour. The reaction mixture was then stirred for 1 h. The final mixture having a solids content of approximately 20% was spray dried to obtain the precursor with the formula LiNi_{0.8}Mn_{0.1}Co_{0.1}(C₂O₄)_{1.5}. The precursor was heated at 600° C. for 5 h under air in a box furnace, heated at 125° C. for 1 h under oxygen flow, and calcined at 830° C. for 15 h under oxygen flow in a tube furnace to obtain NMC 811. The NMC 811 was heated at 125° C. for 1 h and calcined at 830° C. for 15 h under oxygen flow in a tube furnace to form refired NMC 811 referred to herein as “Pristine NMC811”.

### Inventive Example 1

A precursor to NMC 811 having formula LiNi_{0.8}Mn_{0.1}Co_{0.1}O₂ was prepared by adding 0.267 moles of nickel(II) carbonate hydrate (Alfa Aesar, 99.5% metal basis), 0.1 mole of cobalt(II) carbonate (Alfa Aesar, 99% metal basis) and 0.1 mole of manganese(II) carbonate (Sigma Aldrich≥99.9% metal basis) and 0.525 mole of lithium carbonate (Alfa Aesar, 99%) to 200 mL deionized water with stirring for 30 minutes to prepare a carbonate slurry. In a separate beaker, 1.617 moles of oxalic acid dihydrate was added to 400 mL of deionized water with stirring for 30 minutes. The carbonate slurry was added dropwise to the oxalic acid dihydrate mixture over 5 hours an stirred for an additional 18 hours to prepare the oxalate slurry.

The coating solution was prepared by adding 0.005 moles of niobium(V) oxalate hydrate (Alfa Aeser) with stirring over-night. The coating solution was added to the oxalate slurry followed by stirring for an additional 2 hours prior to spray drying. The resulting powder was fired at 830° C. for 15 hours in a tube furnace under oxygen flow. The powder was ground to a sieve size of ≤45 μm and vacuum sealed in an aluminum bag. The resulting powder is referred to herein as 1-pot coated NMC811.

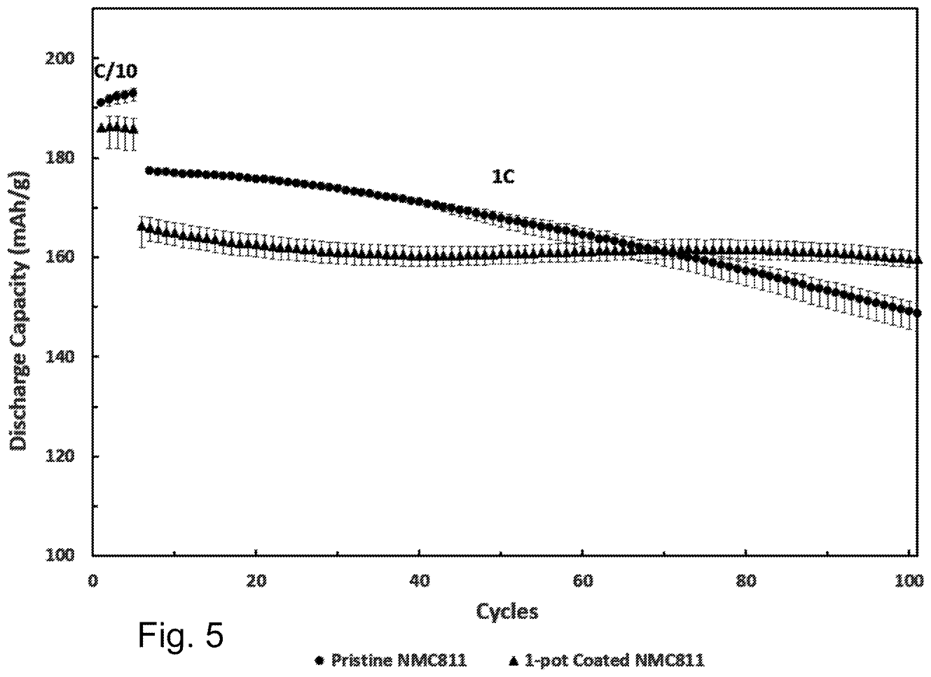

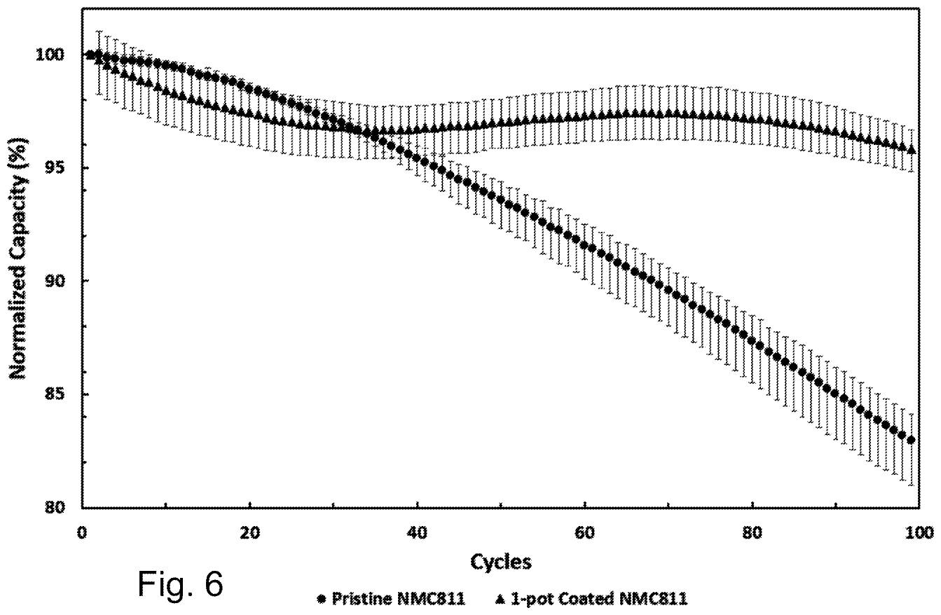

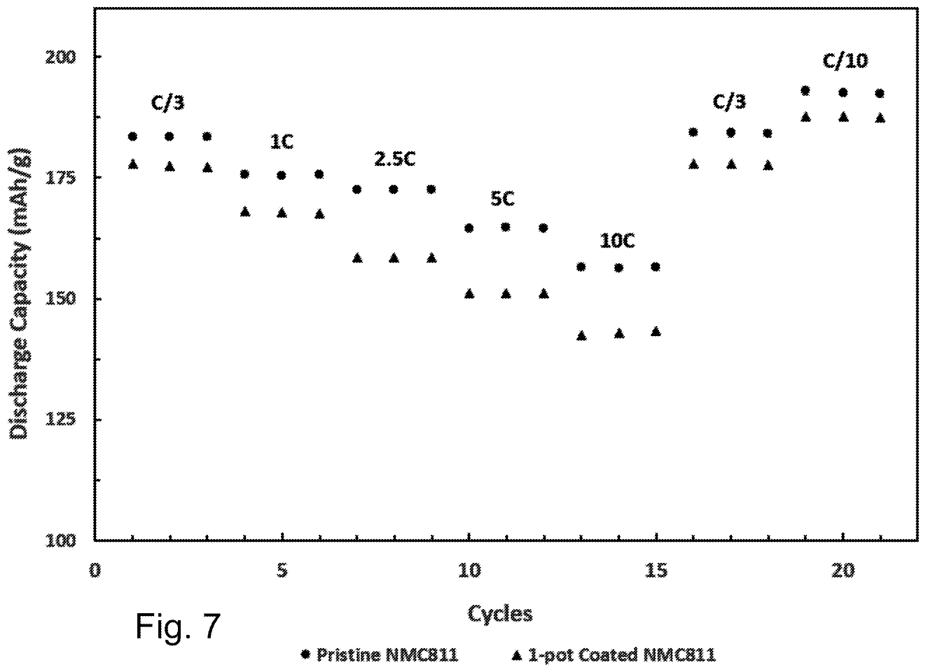

Inventive Example 1 and Comparative Example 1 would be characterized for electrical properties. Inventive Example 1 would show an improved discharge capacity after repeated cycling as illustrated graphically in representative FIG. 5 with the expected normalized discharge capacity illustrated graphically in representative FIG. 6. Expected improvements in the rate capability of the inventive example are illustrated in representative FIG. 7.

### Comparative Example 2

A precursor to NMC 622 having formula LiNi_{0.6}Mn_{0.2}Co_{0.2}O₂ was prepared from 39 g Li₂CO₃, 71 g NiCO₃, 23 g MnCO₃, and 24 g CoCO₃ dispersed in 200 mL of deionized water in a beaker. The mixture of carbonates was pumped into a separate beaker containing 201 g of H₂C₂O₄.2H₂O in 400 mL of deionized water at a rate of 0.38 moles of carbonates per hour. The reaction mixture was then stirred for 1 h. The final mixture, having a solids content of approximately 20%, was spray dried to obtain the precursor with the formula LiNi_{0.6}Mn_{0.2}Co_{0.2}(C₂O₄)_{1.5}. The precursor was heated at 110° C. for 1 h and calcined at 800° C. for 7.5 h under air in a box furnace to obtain NMC 622.

### Inventive Example 2

A precursor to NMC 622 having formula LiNi_{0.6}Mn_{0.2}Co_{0.2}O₂ would be prepared from 39 g Li₂CO₃, 71 g NiCO₃, 23 g MnCO₃, and 24 g CoCO₃ dispersed in 200 mL of deionized water in a beaker. The mixture of carbonates would be pumped into a separate beaker containing 201 g of H₂C₂O₄.2H₂O in 400 mL of deionized water at a rate of 0.38 moles of carbonates per hour. The reaction mixture would then stirred for 1 hour.

The coating would be prepared by adding 3.2 g Niobium (V) oxalate hydrate to the reaction mixture and leaving stirring for an additional 2 hours. The final mixture, having a solids content of approximately 20%, would be spray dried to obtain the precursor. The precursor would be heated at 110° C. for 1 h and calcined at 800° C. for 7.5 h under air in a box furnace to obtain a one-pot coated NMC 622.

### Comparative Example 3

A precursor for NCA with formula LiNi_{0.8}Co_{0.15}Al_{0.05}O₂ was prepared from39 g Li₂CO₃, 95 g NiCO₃, 8 g Al(OH)(CH₃COO)₂, and 18 g CoCO₃ was dispersed in 200 ml deionized water in a beaker. This mixture was pumped into a separate beaker containing 201 g oxalic acid hydrate in 400 ml deionized water at a rate of 0.38 moles of carbonates an hour. The reaction mixture was stirred for one hour. The precursor was heated at 125° C. for 1 h and then calcined at 830° C. for 15 h under oxygen flow in a tube furnace to obtain NCA.

### Inventive Example 3

A precursor for NCA with formula LiNi_{0.8}Co_{0.15}AlOO₅O₂ was prepared from 39 g Li₂CO₃, 95 g NiCO₃, 8 g Al(OH)(CH₃COO)₂, and 18 g CoCO₃ dispersed in 200 ml deionized water in a beaker. This mixture was pumped into a separate beaker containing 201 g oxalic acid hydrate in 400 ml deionized water at a rate of 0.38 moles of carbonates an hour and then stirred for 1 hour.

The coating would be prepared by adding 3.2 g Niobium (V) oxalate hydrate to the reaction mixture and leaving stirring for an additional 2 hours. The final mixture, having a solids content of approximately 20%, would be spray dried to obtain the precursor. The precursor would be heated at 125° C. for 1 h and then calcined at 830° C. for 15 h under oxygen flow in a tube furnace to obtain one-pot coated NCA.

The invention has been described with reference to the preferred embodiments without limit thereto. One of skill in the art would realize additional embodiments and improvements which are not specifically set forth herein but which are within the scope of the invention as more specifically set forth in the claims appended hereto.

1. An improved cathode material for use in a lithium ion battery comprising:
particles comprising an oxide defined by the formula:
LiNiₐMn_{b}X_{c}G_{d}O₂
wherein G is an optional dopant;
X is Co or Al;
a≥0.5;
b+c+d≤0.5;
and d≤0.1; and
each particle of said particles comprises a coating covering a surface of said particle wherein said coating comprises a salt of an oxide of a metal selected from the group consisting of vanadium, tantalum and niobium; and
an agglomerate comprising said particles wherein said agglomerate comprises interstitial interfaces wherein said interstitial interfaces comprise adjacent coatings on adjacent said particles.

2. The improved cathode material for use in a lithium ion battery of claim 1 wherein said agglomerate further comprises interstitial surfaces wherein said interstitial surfaces comprise said coating on each said particle of said particles.

3. The improved cathode material for use in a lithium ion battery of claim 1 wherein each said coating has a thickness of 5 to 10 nanometers.

4. The improved cathode material for use in a lithium ion battery of claim 1 wherein each said coating comprises niobium.

5. The improved cathode material for use in a lithium ion battery of claim 4 wherein each said coating comprising LiNbO₃.

6. The improved cathode material for use in a lithium ion battery of claim 1 wherein said subscript a is defined by the equation 0.5≤a≤0.9.

7. The improved cathode material for use in a lithium ion battery of claim 6 wherein said subscript a is defined by the equation 0.58≤a≤0.62 or by the equation 0.78≤a≤0.82.

8. The improved cathode material for use in a lithium ion battery of claim 1 wherein said subscript d is 0.

9. The improved cathode material for use in a lithium ion battery of claim 1 wherein said X is Co.

10. The improved cathode material for use in a lithium ion battery of claim 1 wherein said G is selected from the group consisting of Al, Gd, Ti, Zr, Mg, Ca, Sr, Ba, Mg, Cr, Cu, Fe, Zn, V, Bi, Nb and B.

11. The improved cathode material for use in a lithium ion battery of claim 1 wherein said G is selected from the group consisting of Al and Gd.

12. A battery half-cell comprising the improved cathode material for use in a lithium ion battery of claim 1.

13. A battery comprising the improved cathode material for use in a lithium ion battery of claim 1.

14. An agglomerate comprising:
particles comprising an oxide defined by the formula:
LiNiₐMn_{b}X_{c}G_{d}O₂
wherein G is an optional dopant;
X is Co or Al;
a≥0.5;
b+c+d≤0.5;
and d≤0.1;
wherein said particles aggregate to form said agglomerate; and
a coating material between adjacent particles in said agglomerate.

15. The agglomerate of claim 14 wherein said agglomerate further comprises interstitial surfaces wherein said interstitial surfaces comprise said coating material on each surface of each particle of said particles.

16. The agglomerate of claim 14 wherein each said coating material has a thickness of 5 to 10 nanometers.

17. The agglomerate of claim 14 wherein each said coating material comprises niobium.

18. The agglomerate of claim 17 wherein each said coating material comprising LiNbO₃.

19. The agglomerate of claim 14 wherein said subscript a is defined by the equation 0.5≤a≤0.9.

20. The agglomerate of claim 19 wherein said subscript a is defined by the equation 0.58≤a≤0.62 or by the equation 0.78≤a≤0.82.

21. The agglomerate of claim 14 wherein said subscript d is 0.

22. The agglomerate of claim 14 wherein said X is Co.

23. The agglomerate of claim 14 wherein said G is selected from the group consisting of Al, Gd, Ti, Zr, Mg, Ca, Sr, Ba, Mg, Cr, Cu, Fe, Zn, V, Bi, Nb and B.

24. The agglomerate of claim 12 wherein said G is selected from the group consisting of Al and Gd.

25. A battery half-cell comprising agglomerate of claim 14.

26. A battery comprising the agglomerate of claim 14.
